(19) United States
(12) Patent Application Publication
(10) Pub. No.: US 2008/0008076 A1
(43) Pub. Date: Jan. 10, 2008

(54) Calibration of Holographic Data Storage Systems Using Holographic Media Calibration Features

(76) Inventors: Daniel H. Raguin, Acton, MA (US); Christopher J. Butler, Medford, MA (US)

Correspondence Address: KENNETH J. LUKACHER, SOUTH WINTON COURT, 3136 WINTON ROAD SOUTH, SUITE 301, ROCHESTER, NY, 14623, US

(21) Appl. No.: 11/578,709

(22) PCT Filed: Apr. 15, 2005
(86) PCT No.: PCT/US05/12786

§ 371 Date: Aug. 27, 2007

Related U.S. Application Data
(60) Provisional application No. 60/563,041, filed on Apr. 16, 2004.

(51) Int. Cl. G11B 7/00

(52) U.S. Cl. 369/103; 359/12; 359/35

(57) ABSTRACT

Calibration of holographic data storage systems (HDSS) is provided by utilizing holographic media (4) having calibration features which can be read, written, or read and written by a HDSS (30). Calibration features may represent for example, surface-relief gratings, holographic recordings, amplitude varying regions, or magnetic regions, or a combination thereof, at locations on or within the media. One or more of the calibration features along media region (302) are media calibration features with media and format information, and other calibration features along region (301) are system calibration features for optically and mechanically aligning HDSS optics. The media (4) may have performance calibration features along region (307) which can be recorded by a HDSS and then read back to determine characteristics of the media. Different HDSS systems can read the calibration features of the media (4) when installed in each HDSS to obtain information about the media, and to optically and mechanically align the media for optimal operation with the media.

This application claims priority to U.S. Provisional Patent Application No. 60/563,041 filed 16 Apr. 2004, which is herein incorporated by reference.

### FIELD OF THE INVENTION

This invention relates to a system, method and apparatus for calibrating holographic data storage systems using calibration features of holographic data storage media, and relates particularly to holographic data storage media having calibration features for optimizing the operation of holographic data storage systems, and systems, methods, and apparatus for holographic data storage utilizing such calibration features. The invention is useful for enabling alignment and analysis of holographic media when installed in different holographic data storage systems, such that each holographic data storage systems can optimally operate with such holographic media for reading or writing holographic data.

### BACKGROUND OF THE INVENTION

Holographic data storage systems (HDSS) operate with suitable holographic data storage media, such as photopolymer material for recording and/or reading of holographic gratings or holograms. For example, photopolymer materials designed as holographic media are marketed and sold by InPhase Technologies of Longmont, Colo., and Aprilis, Inc. of Maynard, Mass. As with any data storage system, it is critical that HDSS optical and mechanical alignments are maintained in order to optimize the performance of the system. With a HDSS, there are a number of opto-mechanical subsystems that require alignment. Such subsystems include, for example, write optics, read optics, reference beam optics, laser and beam shaping optics and mounts, and detector mounts. Such an HDSS is shown for example in U.S. Pat. No. 5,621,549. In page-based HDSS, the opto-mechanics can be complicated since imaging is through a two-dimensional spatial light modulator (SLM) array onto a two-dimensional detector array with an optical system of reasonably high NA (0.3 to 0.7) in order achieve high storage capacities. Unlike the optical system for a CD and DVD, the HDSS should both mechanically and optically align to holographic media as the media physically changes over its usage and environment conditions. Unlike in non-removable data storage media, such as magnetic hard disks, positioning errors often occur when media written by one HDSS needs to be read by another HDSS. It is difficult to ensure absolute alignment of optics, mechanics and media from HDSS drive to HDSS drive, it is therefore desirable to calibrate each drive before a read or write event.

For certain holographic media it may be difficult to ensure absolute media conditions from disk to disk. If holographic media is prone to significant physical and chemical changes over time, these changes can affect the quality of pre- and post-recorded media. Physical changes can occur for example, in photopolymer recording media which relies on the formation of polymer chains within the recording media in order to form holographic diffraction gratings. The formation of polymer chains can be initiated by photonic or thermal energy. In order to record holographic diffraction gratings that are suitable for data storage, it is desirable for the HDSS drive to be able to measure and characterize the amount of pre-recorded polymerization that has occurred in a given media. If the HDSS drive can measure the amount of prerecorded polymerization that has occurred, it would be desirable to set the optimum drive conditions in order to ensure the quality of the recorded holographic gratings. Some of the HDSS drive parameters that need to be optimized for a given media include, for example, exposure energy dosage, object and reference beam incident angles, and media position relative to the optical system.

In addition to measuring the extent of pre-recorded polymerization in holographic media, it is also desirable to measure the extent of volume shrinkage in photopolymer media. Volume shrinkage typically occurs in photopolymer media due to the difference in volume between polymer chains created during polymerization and the unpolymerized monomer media. A detailed explanation of volume shrinkage in photopolymer HDSS media can be found in D. A. Waldman, H.-Y. S. Li, and M. G. Homer, “Volume shrinkage in slant fringe gratings of a cationic ring-opening holographic recording material,” J. of Imaging Science & Technol. 41, 497-514 (1997). Volume shrinkage in a photopolymer media results in a Bragg mismatch, such that the original reference beam used to a record a given hologram is no longer Bragg matched as a reading reference beam for the hologram that is stored within the holographic material. Due to shrinkage, it is also desirable to adjust the planar incident angle of the reference beam to Bragg match the holographic grating and achieve maximum diffraction efficiency during holographic read back. A result of a change in incident angle of the reference beam is a spatial shift in the reconstructed data page image on the detector plane. Therefore it is desirable for a HDSS to be able to measure the volume shrinkage in holographic media and characterize the necessary reference beam angle shift in order to achieve maximum diffraction efficiency. Moreover, it is further desirable to characterize and accommodate the spatial shift of the reconstructed image on the detector plane.

U.S. Pat. No. 5,838,650 describes the use of at least one area of a SLM and of a matching detector array in a HDSS that are reserved for the monitoring and controlling of image quality of the HDSS. Page indicators include information such as page image indicators, page identity information and pixel registration keys. Such page indicators provide image quality improvement via adjustments to the HDSS that originally stored the data page containing such page indicator marks, but not any other HDSS. In this patent, calibration is limited to the adjusting a parameter of the system that originally recorded the page indicators being monitored. Thus, it would be desirable to have calibration features recorded at the factory level, or by another HDSS that is outside of the factory, which can be different from the HDSS reading the calibration features, and farther to provide calibration of media and drive parameters which are not limited to calibration of image quality.

U.S. Pat. No. 5,920,536 describes the use of a page indicator marks for image alignment. A pixel registration key is monitored and if a misalignment between the image pixels and the detector pixels is detected, either the detector or the data page image is moved. Although this patent describes movement of the detector, the data page image is not shifted to correct for misalignment. Further, U.S. Pat. No. 5,982,513 describes the method of tilting the incident reference beam such that the pixilated image of a data page is aligned with respect to the pixels of a detector array. However, neither U.S. Pat. No. 5,920,536 nor U.S. Pat. No. 5,982,513 provide for alignment utilizing any calibration features on the holographic media.

U.S. Pat. No. 6,625,100 describes the use of an optically detectable pattern on a holographic media for the purposes of determining the physical location of a data storage location on the holographic media. The pattern is used for tracking data storage locations on the media, rather than for calibration of the optical and mechanical alignment parameters of a HDSS for the media.

### SUMMARY OF THE INVENTION

Accordingly, it is a feature of the present invention to provide holographic data storage media having calibration features for optimizing the operation of holographic data storage systems, and holographic data storage systems operative with holographic media containing calibration features for optimal holographic recording, reading, or searching of information by any holographic data storage system.

Briefly described, the present invention embodies holographic data storage media having at least calibration features having sufficient information for enabling the optimization of operation of a HDSS with the media. In a first embodiment, such calibration features are holograms holographically recorded into a photosensitive material of the holographic media, and as such are recorded via an index of refraction modulation within one or more materials contained within the holographic media. In a second embodiment, such calibration features may represent surface-relief features along one or more external and/or internal surfaces of the holographic media. In a third embodiment, such calibration features are regions of differing transmission or reflection which store information in changes in amplitude of a signal provided when such regions are illuminated by an incident optical beam. In a fourth embodiment, such calibration features magnetically store information on the media. In a fifth embodiment, such calibration features of a holographic media consist of any combination of surface-relief, volume holography, magnetic, and amplitude features of the first, second, third, and fourth embodiments, respectively.

In all of the above embodiments, one or more of such calibration features may contain information about the properties of the media. Such properties may include but are not limited to media thickness, available media capacity, media sensitivity, required exposure schedule, media manufacture date, or extent of volume shrinkage. Calibration features may also contain information about media format characteristics. Media format characteristics may include for example, location of data fields, location and format of table of contents, location of other calibration features, or sector information. Calibration features that contain information about the media and its formatting are referred to herein as media calibration features. The calibration features that are part of a holographic media may also contain information that allows a HDSS to optomechanically calibrate its systems such that the holographic media can be optimally written and read. Optomechanical calibration alignment may include the proper incident angle of a reference beam (for the example of angle and azimuthal multiplexing), proper media position, or alignment of a holographically reconstructed image relative to a detector array. Such calibration features that serve an HDSS to perform opto-mechanical alignments are referred to herein as system calibration features. Other calibration features are referred to herein as performance calibration features. Performance calibration features are written and read back by a HDSS into a holographic media before actual user data is written. Through reading back the written performance calibration features, the HDSS is able to ascertain the performance characteristics of the media, such as sensitivity and available dynamic range. In this manner, the HDSS can take into account any aging of the holographic media that may change the exposure scheduling required for writing multiplexed holograms as well as the available capacity of the holographic media.

In all of the above embodiments, such calibration features may be located on or within the media at predefined locations. These locations will allow different holographic systems of the present invention to locate and retrieve the calibration features. The calibration features may also, or instead, be located on or inside the media relative to other calibration features that may include for example, regions of differing transmission or reflection, which represent changes in amplitude of a signal provided when such regions are illuminated by an incident optical beam. Such features for locating and retrieving calibration features may also be magnetic and readable by a magnetic head read device. In either case, the calibration features, optical or magnetic in nature, may contain information about the media for calibration or contain information about the location or properties of other calibration features allowing for additional optimization of a holographic system for use with the media.

It is also desirable that the holographic media contain calibration features that are recorded at different stages in the media lifetime. For example, the calibration features may be written when the holographic media is manufactured, or shortly thereafter, but before the holographic media is to be used by the HDSS of a user. This stage of the holographic media life is termed the factory level, and calibration features recorded at this time preferably are media and system calibration features. For example, the factory-level recorded system calibration features serve the purpose of allowing the HDSS of a user to align its opto-mechanics relative to some predefined standard set of alignment parameters used to record the features during manufacturing. In addition to factory recorded calibration features, it may be necessary for the end user to record performance calibration features in holographic media before data is recorded in the media. This allows the properly equipped HDSS to determine the characteristics of the media, which may include for example, the available media capacity, the extent of volume shrinkage, or proper exposure energy dosage for recording. The present invention provides for holographic recording media containing calibration features that are recorded at the factory level or in another system, for example an end-user system.

The invention further provides a system, method, and apparatus for reading information from the calibration features of holographic data storage media when located in a HDSS, in which the HDSS operate responsive to such information for optimizing parameters of the HDSS to ensure optimal operation of the HDSS with the media. Thus, holographic data storage media written in one HDSS can be read by another HDSS, thereby allowing for the interchange of removable holographic media between two or more different holographic optical drives.

In the preferred embodiment, the HDSS of the present invention reads and utilizes media calibration features that are holographic or diffraction gratings. The HDSS may use the primary holographic optical, mechanical and electronic system typically used for reading, writing, or searching of data in order to read and utilize the diffractive calibration features. Alternatively, the HDSS may contain a system in addition to read, write and search system, where the additional system is used for reading diffractive calibration features.

Further, the HDSS may have an optical, mechanical and electronic system, separate from the read/write holographic system, for reading non-holographic or grating calibration features of the media, such as amplitude varying features. By having a separate system, and preferentially one of low complexity and loose tolerances compared to those of the read/write system for user data, the HDSS can be programmed to accept a wide variety of holographic media. This lower complexity system is designed to read calibration features of lower resolution, preferably media calibration features. The separate optical system may be replaced or combined with a magnetic pickup system for reading magnetic calibration features of the media. The operation of an HDSS may be for example, one in that the HDSS first reads the non-holographic or grating calibration features of the media, such as amplitude varying features in order to obtain the location of the system holographic calibration features.

The HDSS reads the media calibration features to obtain information about the media, for example, media properties or media format. Media property information, for example, may include one or more of the following: photosensitive layer thickness, media fabrication date, media fabrication lot number, media sensitivity and exposure schedules, as well as the media manufacturer. Format information, for example, may include one or more of the following: track pitch, reference beam orientations for reading and writing, and location of other calibration features.

Once the HDSS reads such media information and formatting information from the media calibration features, it adjusts its opto-mechanics accordingly and begin to read the system calibration features, whose locations are either recorded in the media calibration features or stored (for example via firmware or software) in the HDSS memory. The system calibration features allow the HDSS to align its holographic read head over one of the calibration areas or regions on the media and fine-tune optomechanical alignment, such as the focus, lateral alignment, and orientation of the reference beam until the signal strength (and hence SNR) from a system calibration feature has been peaked. Such system calibration features allow compensation for slight manufacturing differences between drives as well as for thermal changes in the drive and/or media.

The invention also provides for an HDSS capable of writing, or writing and reading, of holographic performance calibration features on the media to dynamically provide information about characteristics of the media, such that HDSS operating parameters may be adjusted for optimal writing of holographic data. Such parameters, for example, are laser power or write energy dosage.

As stated earlier, calibration features may be written at the factory level. Imparting the media and system calibration features at the factory level can be accomplished by providing surface-relief structures and/or volume holographic features. Such surface-relief calibration features may be molded directly into a surface of the holographic media during one or more stages of the holographic media manufacturing process, while amplitude calibration features may be recorded at the factory level such as by silk-screening, photolithography, or even the use of pressure sensitive materials and laminates with regions of materials of different opacity or reflectivity. Holographic calibrations features recorded in media during manufacturing can be recorded by a well-calibrated holographic factory HDSS. The factory HDSS records holographic calibration features at calibrated reference beam and object beam incident angles and exposure intensities such that an HDSS in the field can read the features. The holographic calibration features can be recorded sequentially with an optical pickup that individually records each of the plurality of holographic calibration features required in a holographic media. The holographic calibration features are recorded and formatted at the factory level in such a manner as to enable an HDSS in use in the field to read holographic media with the holographic calibration features. For example, the formatting can be such that an end-user's HDSS can read at a certain location on the holographic media, and with a reference beam of a suitable orientation and beam shape, the calibration data recorded at the factory level.

The invention also provides for calibration features to be recorded in the holographic media using an HDSS drive operated by an end-user. Calibration features of a known format are written into the holographic media before user data is written. The holographic calibration features are recorded at known locations on the media, such as a disk, and with known data.

These calibration features recorded by the end-user can be used to measure media characteristics. Media characteristics indicated by end-user calibration features may include, but are not limited to pre-recorded extent of polymerization, extent of volume shrinkage, required energy dosage for writing, and available storage capacity.

An example of a system responsive to signals from such calibration features aligns the HDSS to the media over one of more calibration features. The system optimizes at least one of the following degrees of freedom of the HDSS: object and reference beam incident angles, media position relative to the optical system, detector alignment, or SLM alignment are scanned about a local region until the hologram signal to noise is optimized. Once the signal from the system calibration feature is optimized, the proper settings of the HDSS degrees of freedom are recorded for aligning the media, for example, in a look-up table in memory of the HDSS. The degrees of freedom, once stored in a look-up table can be used as a coordinate list for the optimal drive settings for a data write event.

Once calibrated, the HDSS system for reading media calibration features, and aligning utilizing system calibration features, may further be capable of recording and then reading back additional calibration features, e.g., performance calibration features, for the purposes of media calibration, such as prior to each write event. By recording and reading back performance calibration features in the holographic media, the HDSS can determine media parameters such as, for example, photosensitivity, useful dynamic range of a holographic recording media, and the media volume shrinkage. The conditions for optimum calibration feature read-back will not always be known a-priori as the media condition, for example, extent of pre-recorded thermal or photo polymerization in a photopolymer media may be unknown. Therefore the optimal read-back parameters of the HDSS are determined through interactions of read-backs in which each read-back parameter are optimized independently until each read-back parameter is tuned to provide optimum read-back signal to noise ratio with predefined SNR tolerances. Once the read-back parameters have been determined and each performance calibration feature has been read back and evaluated, the pre-recorded state of the media is determined, whereby such optimized parameters are indicative of media photosensitivity and available dynamic range. Media photosensitivity and available dynamic range may be used to determine the optimum conditions for the recording of holographic data on the media and storage capacity of the media.

### BRIEF DESCRIPTION OF THE DRAWINGS

The foregoing features and advantages of the invention will become more apparent from a reading of the following description in connection with the accompanying drawings, in which:

FIG. 1 is a schematic block diagram of a system of the present invention in a holographic data storage system;

FIG. 2 is an optical diagram showing the holographic media and orientation of the object and reference beams used for recording of multiplexing co-locational holographic data on such media;

FIG. 3 is a plan view of an example of the holographic media of the present invention having calibration features on media in a disk format, such as may be used in the system of FIG. 1;

FIG. 4A is a cross-sectional view of the holographic media of the present invention showing an example of a surface relief calibration feature;

FIG. 4B is a cross-sectional view of a portion of the holographic media of the present invention showing an example of amplitude calibration features.

FIG. 4C is a three-dimensional perspective view of a portion the holographic media of the present invention containing holographic calibration features and the read optical module for reading such features;

FIG. 4D is a two-dimensional perspective view of an example of a system calibration page, such as may be read from a holographic calibration feature of FIG. 4C in the system of FIG. 1;

FIG. 5 is a flow chart of the process for reading a sequence of calibration features from the holographic media in the system of FIG. 1;

FIG. 6 illustrates the peristrophic alignment of a holographic data page on a detector array when the holographically stored data is read with the system of FIG. 1; and

FIG. 7 is a flow chart of the process for recording and reading performance calibration features in the system of FIG. 1.

### DETAILED DESCRIPTION OF THE INVENTION

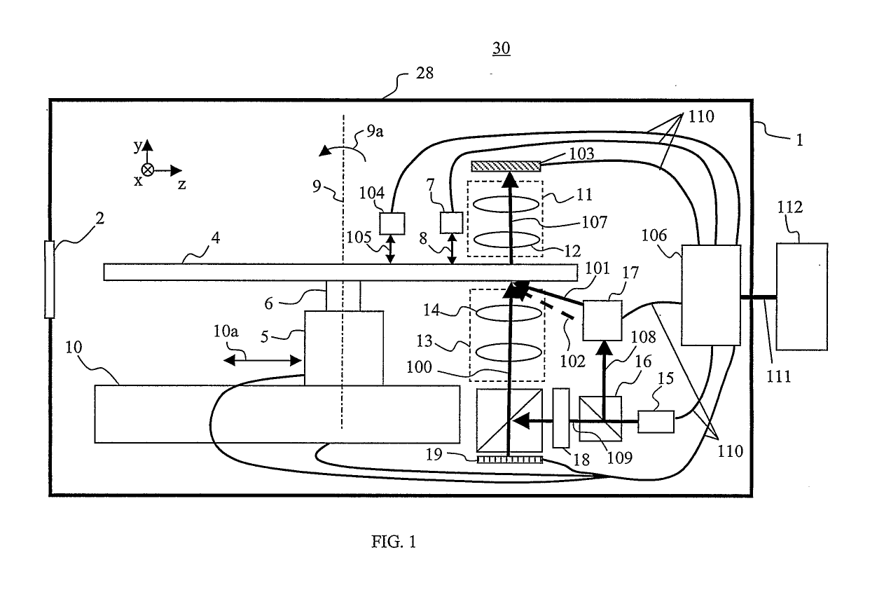

Referring to FIG. 1, a holographic data storage media 4 having calibration features is shown in a holographic data storage system (HDSS) 30. The HDSS has a housing 28 having an aperture 2 through which holographic media 4 can be inserted into the HDSS. In the example of FIG. 1 the media 4 is in the format of a disk. Aperture 2 may or may not be light-tight to illumination such media 4 is sensitive to. Although not shown, the holographic media may be contained within a cartridge and is partially or fully removed through an opening from the cartridge. For example, such a cartridge and HDSS for operating on media removable from the cartridge is shown in International Patent Application No. PCT/US04/33921, and U.S. patent application Ser. No. 10/965,570, both filed on Oct. 14, 2004 and having priority to U.S. Provisional Patent Application No. 60/510,914, filed Oct. 14, 2003. For simplicity of illustration, the cartridge, associated shutters and shutter mechanics for the cartridge, and the cartridge loader (or other movable fixture that accepts the inserted holographic media and ensures that the holographic media is aligned and mated to the mechanics required to actuate the media within the HDSS) are not shown. The media 4 may have a hub, central opening, or other attaching mechanism for coupling the media 4 onto a rotary spindle 6 that is attached to a rotary motor 5. In this manner, the media can be rotated about an axis 9, in a direction designated by the arrow 9a. The rotary motor 5 and spindle 6 represent a rotational stage which is attached to a linear stage 10 that directs the rotary motor and hence the holographic media 4 along the z direction, as indicated by bi-directional arrow 10a, across the stationary optics of a write optical module 13 and a read optical module 11. Through the rotary motion of the rotary motor 5 and the linear translation of the linear stage 10, a large annular portion of the holographic media 4 can be accessed. The geometry depicted in FIG. 1 is an example of holographic media within an HDSS having fixed write and read modules. However, optionally the holographic media 4 may rotate whilst the optical modules for reading and writing move across the media, or the holographic media can be stationary and only the optical modules move physically or at a minimum, direct the appropriate read and/or write beams towards the surface, or the optics can be stationary and the holographic media actuated via x and y translation stages rather than the radial and tangential directions depicted in FIG. 1. The invention may be embodied in the foregoing HDSS system or other HDSS systems using holographic media for read-only or read/write.

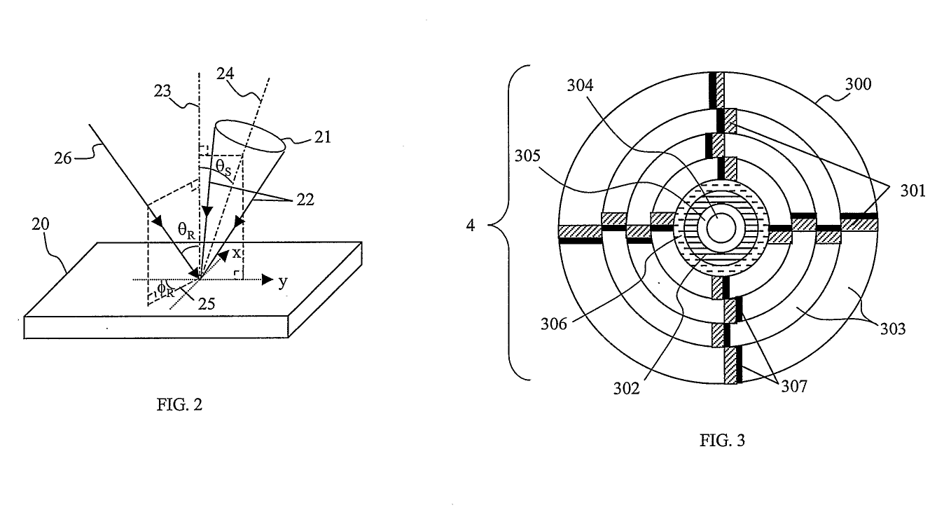

The HDSS 30 has transmissive holographic geometry in that the write optical module 13 and the read optical module 11 are on opposing sides of the holographic media 4. Each of the write and read modules are in general composed of a number of optical elements 14 and 12, respectively. In the example of the HDSS shown in FIG. 1, light from an optical source 15 is split into two beams, reference beam 108 and object beam 109, via a beam splitter 16. The optical source 15 may be a laser source operating at a wavelength of light media 4 is sensitive to. The object beam 109 is preferably beam shaped by a beam shaping optical system 18 such that the intensity falling on a spatial light modulator (SLM) 19 is uniform. The light 100 reflected from the SLM 19 is relayed to the holographic media 4 via the write optical module 13. The reference beam 108 passes from beam splitter 16 through a reference optical system 17 that appropriately shapes the reference beam and allows it to be swept to different angles of incidence on the holographic media for the case of angle and/or peristrophic multiplexing. Depicted in FIG. 1 is an example of reference beam 108 steered to different positions 101 and 102 that may be incident upon the holographic media 4 in the case of such multiplexing. The reference optical system 17 may further permit other forms of multiplexing, such as speckle and shift multiplexing. Reference optical system 17 includes a beam steering mechanism to direct the beam at positions along one or more angular dimensions in accordance with the multiplexing used by the system. Such beam steering mechanism may have one or more movable mirrors which direct the reference beam incident thereto towards the media 4. A moveable mirror represent one example of a beam steering device, other beam steering devices may be used, such as movable optical elements, such as lenses or prisms, or optical modulators. A detailed view of the geometry of the reference beam in relation to the object beam is shown in FIG. 2 and will be described in detail later.

For reading of data from the holographic media 4, the object beam 109 is ideally prevented from illuminating the holographic media. Although not depicted in FIG. 1, the blocking of the object beam can be accomplished by an opto-mechanical system in the path of the object beam after, or in conjunction with, beam splitter 16. Examples of such opto-mechanical system may represent mechanical shutters, EO or AO shutters or deflectors, or the use of polarization rotation devices in conjunction with beam splitter 16 which may be a polarization beam splitter. When reading the data stored in the holographic media 4, the reference beam 108 illuminates the holographic surface of media 4 with a series of reference beam orientations and wavefronts that match the orientations of the reference beams used during the writing process. When a given reference beam that matches a reference beam used in the recording process illuminates the media, the stored hologram can be read and the diffracted light 107 from this hologram is captured by the read module 11 and imaged onto a detector 103, such as a two-dimensional charge-coupled device (CCD) or a complementary metal-oxide-silicon (CMOS) array. In addition to read or write operations, the holographic optical system may also provide searching operations to locate holographic recorded data on the media. The search process is similar to a read however the media is scanned with a reference beam having the data being searched for until, a hologram having such data is read.

During both read and write cycles of the HDSS, a servo system 7 is used to track the media. The servo system 7 can be used to track the position of the holographic media 4 as well as to obtain such information as of the holographic media surface. In one example, the servo system is optical and has an optical source, preferably of a spectral bandwidth that does not include wavelengths the holographic media is sensitive to, and reflects an optical beam 8 off of a surface of media 4 to obtain address information from reflective marks (encoding radial and angular positions of the disk media) onto a detector of the servo system. Although drawn as a reflective system, the optical servo system is not limited to reflection and can operate in transmission or a combination of reflection and transmission. An example of a reflection optical servo system 7 is the use of a CD or DVD pick-up head. By having pits and grooves similar in size as those found in CD or DVD disks, one can encode such pits and grooves with address information and use the same optical pickup head as that used in CD or DVD drives with electronics (and/or software) that interpret the data read.

A separate reader system 104 may be incorporated into the HDSS to read some of the calibration features on media 4. Such reading system is preferable when the calibration features being read are of lower resolution than the system calibration features on the media disk and it is preferable that such lower-resolution calibration features contain information regarding media and format (e.g., the media calibration features). Media information should preferably include information, such as thickness of the photosensitive layer, manufacture date, sensitivity, and exposure dose schedules. Format information for example may contain such information as location of system calibration features on media 4, in terms of disk radial and annular position as tracked by servo system 7, and the reference beam settings required to read such system calibration features. In one example, the reader system 104 contains an optical source that probes the holographic media 4 with an optical beam 105 to read the calibration features on the holographic media. In another embodiment, the reader system 104 contains a magnetic head that reads magnetically coded calibration features on the holographic media.

The opto-mechanical systems in an HDSS require dynamic control and are connected via cables (e.g., electrical or optical), to one or more controllers 106. The controllers 106 within the HDSS can perform a multitude of tasks including, but not limited to, the control and timing of the data displayed by the SLM 19, the modulation and power levels of the optical source 15, the decoding of data received from the detector 103, the servo 7 controls for tracking the holographic media 4, the control and timing of the reference beam 108 wavefront and orientation for the multiplexing configuration of the HDSS (e.g., via motors coupled to the movable mirrors or other beam steering device(s) used), and the control of the reader system 104 reading calibration features on the holographic media. The controllers 106 can also supply any electrical power needed by these various opto-mechanical systems via the connections illustrated by 110. The HDSS internal controller(s) 106 may represent one or more programmed microprocessor-based devices, which are connected to an external controller 112 via a connection 111. This external controller could be a variety of controllers that include, but are not limited to, a personal computer, an enterprise library data storage system, or a computer server.

FIG. 2 shows the exposure geometry of the reference and object beams along a portion of the holographic media surface 20 of media 4. Typically, the cone of the object beam, described by the cross-section 21 and cone boundary rays 22 is propagating along a carrier plane wave 24 that makes an angle θ_{S} with respect to the local surface normal 23 of the holographic media 4. The reference beam is propagating on a carrier plane wave 26 that makes an angle θ_{R} with respect to the local surface normal and whose projection 25 in the x-y plane (plane defining the orientation of the local surface of the holographic media) is at an angle φ_{R} with respect to the y axis. The reference beam itself can be any form of coherent beam, such as a plane wave, a converging beam, or a diverging beam, provided that it is propagating along a carrier plane wave defined by the angles θ_{R} and φ_{R}. With this definition of the angle φ, the object beam's projection into the x-y plane, makes an angle of φ_{S}=180° with respect to the y axis. The reference beam need not be a plane wave but could be a diverging or converging reference beam such as one would use for shift-multiplexing of holograms, such as described, for example, in G. Barbastathis, M. Levine, and D. Psaltis, “Shift multiplexing with spherical reference waves,” Appl. Opt. 35 (14) 2403-2417 (1996). For angle multiplexing, the angle θ of either or both of the object beams and reference beam changes between exposures by a value larger than the Bragg selectivity of the previous hologram stored in the holographic media. Angle multiplexing is described, for example, in H. S. Li and D. Psaltis, “Three-dimensional holographic disks,” Appl. Opt. 33 (17), 3764-3774 (1994). Since θ is defined with respect to the local surface normal of the holographic surface, tipping and tilting the holographic media can also be accomplished for the purposes of angle multiplexing. For the case of peristrophic or azimuthal multiplexing, see for example U.S. Pat. No. 5,483,365, in which the orientation of φ is changed by some combination of the media, the reference beam, or the object beam rotating about the z-axis.

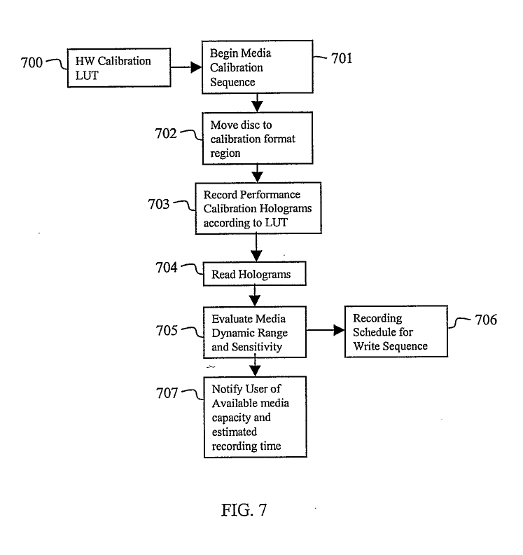

Referring to FIG. 3, an example of a holographic media 4 with calibration features is shown that may be used in HDSS 30. In the top-down view of a holographic media 4, the media is in the form of a disk having an outer diameter 300 and an inner diameter 304. Within the inner diameter 304 may be a hole providing a hub upon which the media can be inserted onto the spindle 6 of rotary motor 5. The user data is written in a number of sectors 303 about the disk. Each sector, as illustrated, represents an angular wedge portion of an annular region of the holographic media. The regions 301 of the holographic media that are shaded with slanted hash marks denote the plurality of system calibration features distributed about the holographic media. The regions 307 of the holographic media that are blackened denote the plurality of regions available for performance calibration features to be recorded in the holographic media. As will be detailed later, in particular with reference to FIG. 7, the performance calibration features are recorded by the user HDSS and are used to determine current media parameters, such as the photosensitivity and data capacity that is available before the user HDSS commences a recording session of user data. In this example, there is one region of system calibration features and one region of performance calibration features for each sector of user data. The region 302 contains media calibration features and is located towards the center of the disk, while region 305 is the center annular of the disk which typically would not be used for calibration features or data due to possible conflict with the physical layout of the rotary motor. Media calibration features providing media and formatting information, respectively, are integrated into the holographic media such as at the factory level, while the system calibration features could be recorded by a factory HDSS or user level HDSS. The annular region 306 marked by the horizontal dashed lines denotes a table of content (TOC) sector. In the TOC sector is the information required by the HDSS to determine data stored on the holographic media. Such TOC information may include, for example, physical sectors or memory locations, i.e., physical space (e.g., disk radial and disk angular position) with the reference beam settings required to address the stored multiplexed holograms on the media disk 4 where user data has been recorded, file names and types and directory structures for the user data recorded, and memory locations available for storing new user data. The TOC sector is preferentially a region of the holographic media that can be recorded and read multiple times, thereby allowing the holographic media to have a plurality of read and write sessions. Alternatively, the TOC sector may be a region containing phase change media, similar to that incorporated into recordable CDs or DVDs. Such phase change media would allow a properly equipped HDSS containing a read and write head similar to that of a CD or DVD player to record TOC information to be read by the same or another comparably equipped HDSS.

Media 4 may be composed of a top substrate and a bottom substrate which sandwich photosensitive material suitable for holographic recording in the volume of such material. The substrates may be of glass or plastic material. All sides of the media may also be of such substrate material, thereby encasing such photosensitive material therein. For example, such holographic data storage media is sold by Aprilis, Inc. of Maynard Mass., and may be in different formats, such as a disk described herein, a card, or other shapes.

There are at least four types of calibration features which may be incorporated on holographic media 4, that may include surface-relief grating features, amplitude features, magnetic features, and holographic recorded features. Surface-relief grating features or holographic features may be used for aligning the angles of the reference beam to the media. Amplitude and magnetic features preferentially provide encoding of media and format information. Holographic features or surface relief gratings may also be used for alignment of read data page upon the detector. Preferably, the system calibration features of a holographic media consist of holographic features, however other combinations of surface-relief, volume holography, magnetic, and/or amplitude features may be used. Each type of calibration feature is described below.

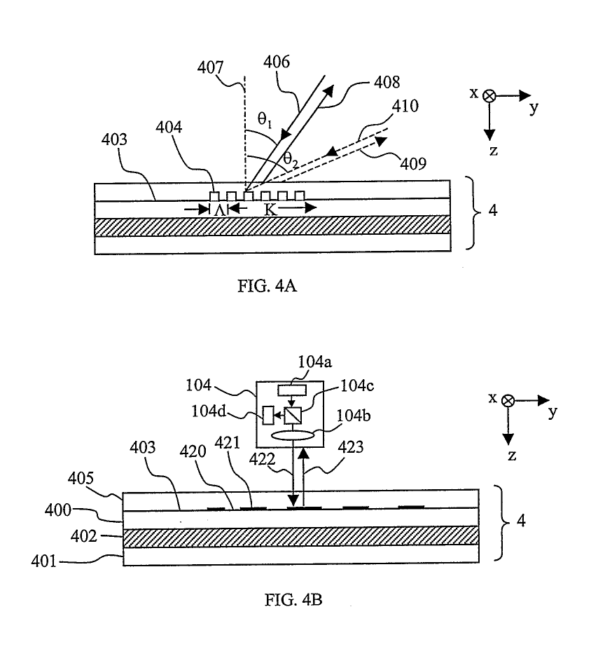

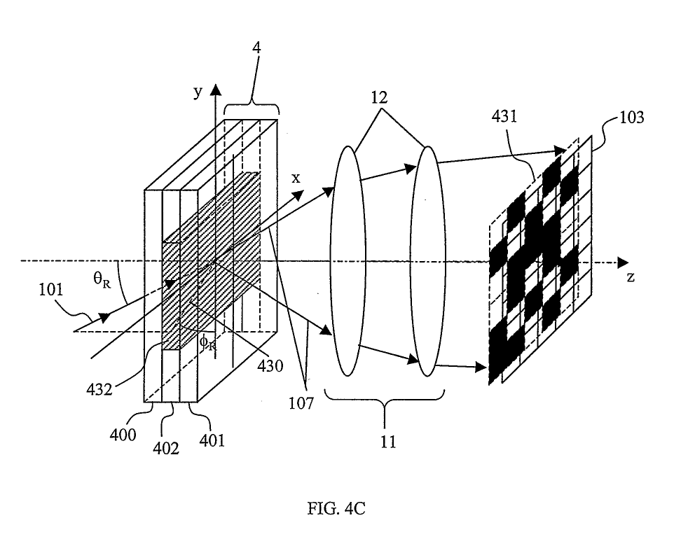

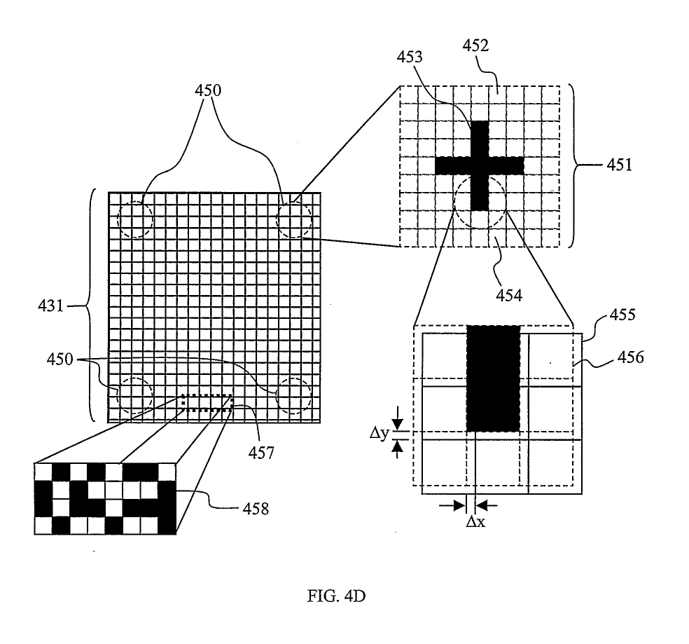

FIG. 4A depicts a cross-section of a holographic media 4 that contains a calibration feature that incorporates a surface-relief grating. Such a grating calibration feature can be used to calibrate the θ and φ angle orientations of the reference beam in a HDSS that incorporates angle and or peristrophic methods for the co-locationally multiplexing of multiple holograms. In the example depicted in FIG. 4A, a holographic media 4 is composed of a top substrate 400 and a bottom substrate 401 that are sandwiching a layer of photosensitive material 402. On the top surface 403 of the top substrate, a series of grating grooves 404 with grating period Λ are fabricated and oriented such that the grating vector K lies along the y-axis (e.g., K=2π/Λŷ).

Over the top substrate 400 is a coating 405 that protects the grooves from scratches. An example of such a holographic media construction is Type A material sold by Aprilis, Inc., Maynard, Mass. The photosensitive layer and the bottom and top substrate materials may, for example, be of polycarbonate material, with an index of refraction of 1.58. The coating layer 405 may, for example be another organic material with an index of refraction of 1.46, for example, thereby allowing sufficient index of refraction difference between the coating layer and the polycarbonate layer for diffraction to occur and be detectable. Optionally, the grating grooves are metal-coated (e.g., Al) in order to enhance the power in the reflected diffracted light. Preferentially the grating is designed to operate in the Littrow configuration, and as such will take light of a specific angle of incidence and reflect it directly back at the source. As shown in FIG. 4A, light 406 that is incident at an angle θ₁ relative to the surface normal 407 of the holographic media 4 has a reflected diffracted order 408 that counter-propagates relative to the incident beam 406. The grating features may provide for a second incident beam 409 propagating at an angle of incidence of θ₂, to also reflect a diffracted order 410 that counter propagates relative to the second incident beam 409. The Littrow condition can be expressed as

$$sin {θ}_{i} = \frac{m λ}{2 {n}_{i} Λ} , \qquad ( 1 )$$

where θᵢ is the angle of incidence of the incident light relative to the surface normal of the holographic media, m is the diffraction order, X is the free-space wavelength of the incident light, nᵢ is the index of refraction of the medium outside of the holographic media (typically air, so nᵢ=1), and Λ is the grating period of the grating grooves of the calibration features. A plurality of gratings can be provided each to be used as a separate calibration feature for a different angle of incidence requiring calibration, or a single grating can be provided that operates at multiple angles of incidence. As an example, consider the case of λ=405 nm, Λ=1900 nm, and nᵢ=1. In this case, the angles θ₁ and θ₂ that would satisfy the Littrow condition would be 39.75° and 58.50° for m=3 and m=4, respectively. Note that a grating with a grating vector K along the y-axis could calibrate more than one θ angle, but could at most calibrate the φ=0° and 180° angles (i.e., incident light whose propagation vector projected onto the x-y plane has a component in the ŷ or −ŷ directions and no x-axis component). For calibrating p number of phi angles (assuming that none of these angles are related to each other by a 180° rotation in phi), one would require p gratings with grating vectors Kₚ such that the direction corresponds with the φₚ direction of the incident light. In a simplified example, a crossed grating can be provided, wherein the two grating vectors are oriented at 90° relative to each (for example one in the ŷ direction and one in the \hat{x} direction). For example, in one direction the grating period may be 1900 nm as described earlier in this paragraph, while in the orthogonal direction, the grating period could be 2000 nm such that a reference beam oriented at 37.41° and 54.10° can be calibrated. The two gratings need not be oriented at 900 relative to each, but can be set at an arbitrary angle relative to each other, and more than two orientations of gratings (all of which may or may not have different grating periods) can be fabricated. For example, the fabrication of such gratings is described in M. C. Hutley, “Coherent photofabrication,” Opt. Engin., 15, 190-196 (1976), wherein crossed gratings are fabricated holographically in photoresist. These photoresist structures can be transferred to another medium via an etching or replication process, such as those described in Micro-Optics: Elements, Systems, and Applications, ed. by H. P. Herzig (Taylor & Francis, Inc. Bristol, Pa., 1997).

The surface-relief calibration features may be fabricated in one or more external and/or internal surfaces of the holographic media. In the case of surface-relief calibration features that reside along an internal surface of the holographic media, a sufficient index of refraction difference in required at the interface of the internal surface such that the surface-relief features can be detected via transmission, reflection, and/or diffraction changes in an incident optical beam. In a preferred embodiment of these surface-relief calibration features, the features are replicated into a surface of the holographic media. For example, for a holographic media composed of a photosensitive media that is sandwiched by two plastic substrates (for example, polycarbonate substrates), the calibration features can be molded directly into the surface of the plastic substrate during the same molding process used to fabricate the substrates. The surface-relief calibration features may be directly fabricated, or preferably a master is fabricated that is used to mold the calibration features. Such fabrication may be by photolithography, e-beam lithography, laser writing, wet aqueous etching, dry etching, and electroforming processes. The aforementioned manufacturing processes for the purposes of creating surface-relief features are to be considered as examples; other methods for producing such features may also be used.

FIG. 4B shows a cross-section of a holographic media 4, similar to FIG. 4A, except that the calibration features have amplitude features. The reader system 104 used to read the amplitude features has an optical source that projects an incident optical beam 422 towards the holographic media 4 at an angle that is preferentially normal to the surface, but non-normal incident light may be used. The incident optical beam 422 reflects off of the reflective marks 421 that have been patterned on the top surface 403 of the top substrate 400 of the holographic media. The change in length in the y-direction of the amplitude features compared to the clear features 420 can be detected by the timing of the reflection signal incident upon a detector integrated into the optical system 104, whilst the holographic media 4 is moving in a direction having at least a motion component in the y-direction. The change in the length in the y-direction of the amplitude features as well as their relative spacing can be used to code information required as part of the media calibration features, such as may be located at features 302 in media 4, as described earlier in connection with FIG. 3. An encoding scheme may be provided for the serial data provided from detector of reader system 104 to controller 106. For example, run-length-limited (RLL) encoding may be used (e.g., such as those used in CD and DVDs), or bar-code type encoding similar to that used with UPC labels, or other data encoding schemes. The reader system 104 has a light source 104a and optics 104b which shape and/or focus the beam from the source onto the media 4, and light returned from the media may be shaped and/or focused by the same, or different optics, onto the detector 104d contained within reader system 104. A beam splitter 104c in the reader system 104 pass the beam from the source 104a to optics 104b, while directing return light received to detector 104d. Amplitude calibration features can be manufactured through a variety of techniques, such as silk-screening, photolithography, or through the use of pressure sensitive materials and laminates that have regions of different opacity.

As an example, the reader system 104 can use an optical beam from a 655 nm semiconductor source 104a that is focused with a slow (NA=0.10) objective lens 104b onto the media surface containing the reflective marks 421. The focused spot size is approximately 8 μm in diameter and through Gaussian beam propagation has about ±100 μm of defocus error before the spot increases past 13 μm. The reflective marks can have a code such that the minimum length of a clear area 420 or reflective area 421 can be 15 μm. When illuminated, the reflective marks provide return reflected light representative of a code detectable by an optical detector 104d of system 104. By using such a slow optical system for reading the amplitude calibration features, loose opto-mechanical tolerances that ensure the holographic media is able to be immediately read upon being inserted into the HDSS.

Magnetic calibration features can magnetically store information in an encoded format on holographic media 4. However, whereas amplitude-varying features can be formed in the media material, magnetically recordable material is applied to the media surface(s), e.g., on the surface of one or more of the substrates sandwiching the photosensitive material of the media or on the coating applied thereto. Magnetic features may be similar to a magnetic strip of an identification badge or credit card, such that the reader system 104 has a magnetic pickup system having a magnetic read head. The magnetic strip is encoded with the media and formatting information similar in the manner in which a credit card or identification badge magnetic strip is encoded. The magnetic pickup system is disposed in the HDSS such that when media 4 is inserted in the HDSS the magnetic pickup system reads the magnetic features from magnetically encoded region(s) and provides electrical signals to a controller 106 of the HDSS representing the encoded data which may then be decoded by the controller. Attaching means of such strip to a surface of one of the media substrates may be similar to that used in a credit card, or may be a magnetic strip attached by adhesive material.

FIG. 4C shows an example of calibration features that are holographic. In this example, the HDSS is multiplexing co-locational holograms using plane-wave angle and azimuthal multiplexing and the optic axis of the read optical module 11 coincides with the surface normal, defined as the z-axis, of the holographic media 4. A reference beam 101 is incident on a calibration feature 432 at an angle of θ_{R} (as measured with respect to the surface normal z) and φ_{R} (the angle the x-y plane projection 430 of the reference beam's propagation vector makes with they axis). The diffracted light 107 from the calibration feature is imaged by the optical elements 12 of the read optical module 11 and the resulting image 431 referred to as the calibration or alignment page, which is composed of a series of light and dark pixels, is projected onto detector array 103. In this example, the holographic calibration features have been recorded with holographic data with an HDSS similar to that illustrated in FIG. 1, with the calibration features preferentially recorded at the factory-level, if the holographic calibration features are system calibration features. These holographic calibration features in general store a plurality of holograms, each designed to be read by a reference beam with a specific θ_{R} and φ_{R} orientation, so that reference beams of multiple orientations can be used to calibrate the opto-mechanical alignment of the HDSS reading the calibration features. In this manner, these calibration features are system calibration features. One or more of such holographic system calibration features may provide data pages when read wherein said data pages have pixels of known two-dimensional location (x,y) or marks which are aligned with pixel positions of the detector array of the HDSS and/or may have holographic data describing the original recording parameters of the holographic calibration feature in the media.

The holographically recorded calibration features are recorded into the holographic media and as such are recorded via an index of refraction modulation within one or more materials contained within the holographic media. The location of the material of media 4 in which the holographic calibration features are recorded may or may not be the same location as is used to record and/or playback data, termed user data, that the holographic media is intended to store for the end user. The holographic calibration features are detected through the use of an incident optical beam that will diffract in reflection and/or transmission upon encountering the holographic features. The incident optical beam may or may not be the same optical beam or be from the optical source as that used for recording and/or reading user data. In a preferred embodiment, the holographic calibration features can be read by the same optical system used to record and/or read user data, and in this method, direct feedback with regards to the opto-mechanical alignment settings for the optical system can be obtained.

An example of a calibration page 431 recorded in a system calibration feature is shown in FIG. 4D. In this example, the calibration page 431 has four locations 450 wherein alignment marks are placed. These alignment marks are composed of a set of pixels 451, whose composition is known (through the reading of media calibration features or through data stored in the firmware memory or software of the HDSS) by the HDSS reading the calibration page, wherein some pixels have no light 452 and some have light 453. In this example a simple cross-hair is used as the alignment mark, but a plurality of marks and different mark formats may be used. Looking at a close-up of a smaller region of pixels 454 with respect to the detector 103 pixels, the calibration page pixels, e.g., 456, are not properly registered relative to the detector pixels, e.g., 455, and in general have misalignments in the x and y directions of Δx and Δy, respectively. The alignment marks of the calibration page can be used to align the opto-mechanics of the HDSS. The calibration page, preferentially, has a region of the page 457 that is referred to as a calibration page header. The calibration page header is dedicated to storing data in a set of pixels 458 that indicates properties of the calibration hologram. Properties of the calibration hologram that are recorded in the header may include, for example, the address of the hologram within a series of calibration holograms, the incident angle of the recording reference beam, the expected amount of media volume shrinkage, or energy dosage used for recording the calibration hologram. For the example of a HDSS that is designed for planar angle and azimuthal multiplexing, the term “address” of a hologram on media 4 has four components, a physical position at a radial degree and angular degree on the disk, as determinable from tracking information from servo system 7, and the angles θ and φ. The physical position may be in accordance with mechanical position encoders of rotary motor 5 and linear translation stage 10, and/or software in controller 106 for sending signals to such motor and stage. Angles θ and φ are set by beam steering mechanism of the reference beam at such physical position in accordance with signals received from controller 106. However, other physical addressing may be used depending on the format of the disk, such as x and y orthogonal dimensions for a media card, and using translation stages to control movement along such dimensions in accordance with signals from controller 106.

The calibration features can be written on the media 4 at different stages of the holographic media's lifetime. For example, the calibration features may be written when the holographic media is manufactured, or shortly thereafter, but before the holographic media is to be used by the end user. This stage of the holographic media life is termed the factory level. For the case of surface-relief calibration features, the calibration features, as stated earlier can be molded directly into a surface of the holographic media during one or more stages of the holographic media manufacturing process. In the case of amplitude calibration features, these features may be recorded at the factory level such as by silk-screening, photolithography, or even the use of pressure sensitive materials and laminates with regions of materials of different opacity. In another example where the calibration features are holographic, such features are recorded holographically in one or more suitable photosensitive materials contained within the holographic media 4. Holographic calibrations features recorded in media 4 during manufacturing can be recorded by a well-calibrated holographic factory HDSS. The factory HDSS records holographic calibration features at calibrated reference beam and object beam incident angles and exposure intensities such that an HDSS in the field can read the features. For example, the holographic calibration features can be recorded sequentially with an optical pickup that individually records each of the plurality of holographic calibration features required in a holographic media. In a preferred embodiment, a group of the features are recorded in parallel via what is termed holographic replication. In this manner, a reduced number or exposures is required to record all of the holographic calibration features for a holographic media. Such holographic replication is described in International Patent Application No. PCT/US2004/044017, having priority to U.S. Provisional Patent Application No. 60/533,296, filed Dec. 30, 2003, by inventors Daniel H. Raguin, David A. Waldman, M. Glenn Homer and George Barbastathis, and which is herein incorporated by reference. In a preferred embodiment, a single exposure is required to record the holographic calibration features required for one or more holographic media.

The formatting can be such that an HDSS with the appropriate embedded firmware or software drivers programmed with information that at a certain location on the holographic media and with a reference beam of a suitable orientation and beam shape, the HDSS can read the calibration data that was recorded at the factory level. Alternatively, or in addition to information from such drivers, low-resolution calibration features, e.g., amplitude or magnetic calibration features located, for example, at the inner tracks of a disk media as described in FIG. 3, are read by the HDSS in order to determine the formatting of the holographic media that has been inserted into the system. These features are media calibration features and provide format information from which the holographic drive can determine where the system calibration features are located on the holographic media. In addition, the media calibration features may contain information regarding the properties of the system calibration feature(s), allowing the HDSS to properly read the system calibration feature(s). Such properties that may be contained in media calibration features may contain for example, the nominal reference beams settings required to read the system calibration features.

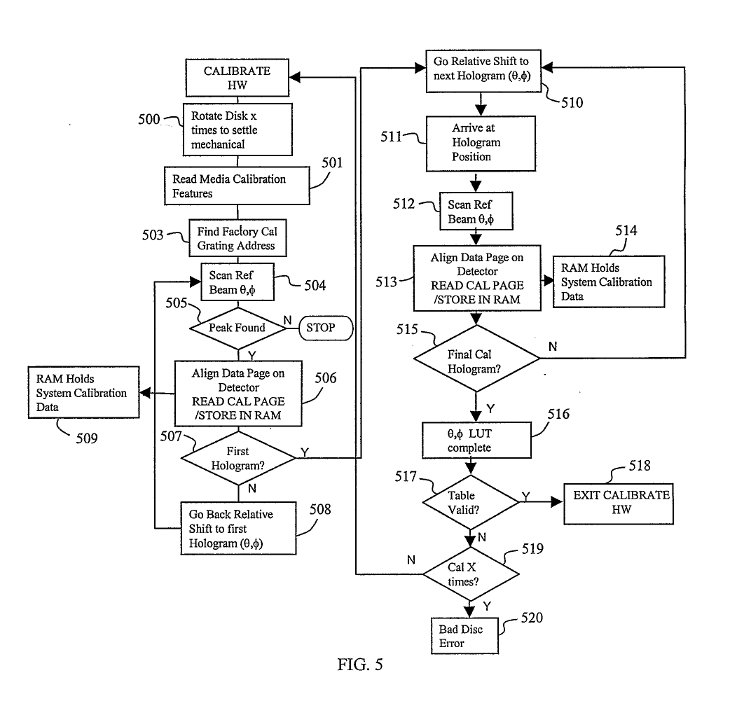

An example of the operation of a system utilizing media and system calibration features is shown in FIG. 5. The operation of the HDSS 30 is shown to calibrate the holographic data storage system or drive using factory-recorded calibration features. Prior to starting the calibration operation, the holographic media 4 with the calibration features has been inserted into the drive of the HDSS and the media has been engaged by the drive mechanism, for example, a spindle 6 chuck coupled to rotary motor 5 for spinning the media 4. Although a spinning disk media is described, other embodiments may include stationary media formats, such as a media card, or any other holographic media formats where the HDSS has means for moving such media relative to the read and write heads of the HDSS. The calibration sequence begins by first rotating the spinning media to assure that the media is in a mechanically stable state (step 500). For example, the hub of the media may not properly engage the media chuck. In such case, spinning the media may help to mechanically stabilize the system. Next, the HDSS reads the media calibration features (step 501 ) to determine the location and properties of the system calibration features on the holographic media.

In order to read the media calibration features, the separate reader system 104 reads the media calibration features detailing format and media information. For the case wherein the separate reader system is an opto-mechanical read system, an optical beam 105 is produced to probe the holographic media 4 at specific regions in order to read the media calibration features detailing format and media information. As shown in FIG. 1, the separate reader system 104 operates in reflection, so light reflected from the calibration marks are read by a detector, for example, a PIN photodiode, contained within the reader system 104, which converts the light into electrical signal received by controller 106. Such signal when decoded by the controller provides media and formatting information, as described earlier. The region(s) storing the encoded media calibration features may be along any predetermined region(s) on the disk, such that the reader system 104 will be directed to such regions to read such data when the disk is first inserted, or rotated. Each media disk would thus have the approximately same area of the disk with such regions storing the encoded information. For example, region 302 in the case of media disk 4 of FIG. 3, encoding such information provided to the disk at the factory level. Optionally the reader system 104 may be on a rotation and/or translation stage and be movable with respect to the media, such that controller 106 may send signals to such stage to direct the reader system 104 to the region(s) encoding media and formatting information. As earlier described, optionally the reader system 104 may incorporate a magnetic pickup head which would be similarly located to read region(s) such as a linear or annular strip magnetically encoding the media and format information, or both opto-mechanical and magnetic read systems may be used such that different types of media may be read.

Once the HDSS reads such media and formatting information from the media calibration features, it can adjust its opto-mechanics accordingly in preparation for reading system calibration features on the holographic media. For example, by reading the media calibration features (or optionally through data stored in its internal firmware or software of the HDSS), the HDSS can determine that the media contains, for example system calibration features that each contain 200 co-locational system calibration holograms that are angle and azimuthally multiplexed. Furthermore, in this example, the HDSS will determine that for reading multiplexed holographic system calibration features there are 4 azimuthal angles of φⱼ=0°, 60°, 120°, and 180°, and that the 50 theta angles θᵢ for each of the angles φⱼ are arranged from 40° to 64.5° with spacings of 0.5°. Furthermore, through data stored in the media calibration features or in HDSS firmware or software, the HDSS can determine the location on the holographic media where system calibration features are located that the HDSS can use in order to calibrate its reference beam to the standards set at the factory level.

The next step (step 503 ) is for the HDSS to align its optical system for reading and/or recording holographic data over the system calibration feature closest to the sector of the holographic media that the HDSS will be reading and/or writing user data to. This alignment step is accomplished through a combination of movement of the media, such as via motor 5 and/or stage 10 (and/or movement of the optical system of the HDSS if not stationary). The HDSS is able to find the address (i.e., physical location or space on the media in terms of disk radial and angular position) of the system calibration features through the use of servo system 7 and addressing features read from the holographic media, wherein the addressing features may be those as described in U.S. Pat. No. 6,625,100. Thus, the media 4 is positioned at a location where optics of read module 11 can detect diffracted light from the media in response a reference beam incident the media. In another embodiment, a break-beam sensor is used to measure an absolute position on a media with opaque markings on the substrate. In this embodiment, calibration features are located at some known relative displacement from the opaque markings on the holographic media. The relative displacement can be measured, for example, by using encoders on all of the media and/or optical head axes of travel.

Once the optical system of the HDSS is aligned above the desired system calibration feature, it is necessary for the HDSS to read the holograms stored in the system calibration feature. In this example, consider that the holograms are angle and azimuthally multiplexed and so the reference beams required for readout of the system calibration features are at known angle θᵢ and azimuthal φⱼ reference beam 101 orientations, see FIG. 4C, as provided by the media calibration features and/or the HDSS software or firmware. Such azimuthal multiplexing (also termed peristrophic) may be such as described in the earlier referenced U.S. Pat. No. 5,483,365, and angle multiplexing in the earlier referenced Li et al. article. In the case of the media shown in FIG. 3, system calibration features may be stored in different disk sectors along regions 301, but such system calibration features may be in other areas of the media.

In the preferred method, the HDSS initially orients the optomechanics of the system to address the first stored hologram in the series of holograms stored within a given system calibration feature. For the case of planar angle and peristrophic multiplexing, this first hologram is stored with a reference beam oriented at θ₁ and φ₁. In order to address any one of the calibration holograms individually, it is necessary to provide a reference beam identical to the reference beam that recorded the hologram. In the preferred embodiment, the holographic drive achieves multiplexing by changing the incident angle of the reference beam within a plane (known as planar angle multiplexing) and also out of the plane (known as peristrophic or azimuthal multiplexing). Due to drive-to-drive mechanical tolerances, thermal effects, and tips and tilts of the holographic media as mounted in the specific HDSS, the angle and azimuthal setting for the HDSS reference beams may differ from the absolute incident reference beams used to record the system calibration features at the factory. Consequently, the HDSS must scan the incident beam angle over some angular range of θ and φ to find the angular position of the desired system calibration hologram (step 504 ). The range over which the incident angles need to be scanned relates directly to the tolerances of the drive/media system in addition to drive-to-drive, and media-to-media variability. Where planar angle and azimuthal multiplexing is used, it is necessary to first scan the incident reference beam planar angle at some nominal azimuthal angle φ in order to maximize the diffraction efficiency of a calibration hologram in angle θ. The diffracted intensity of light produced by the system calibration hologram is measured upon detector array 103 (such as averaging the value of all pixels received upon the detector) such that the planar angle θ is adjusted until the intensity falling on the drive detector array 103 is maximized. During optimization of the read beam θ angle, the drive determines the θ location of the peak-diffracted light for a given hologram (step 505 ). The intensity of the beam diffracted from the hologram during read-back is determined by the ability of the planar angle of the read reference beam to satisfy the Bragg condition. As the incident reference beam planar angle is swept over a range of angles, the intensity of the light diffracted from a hologram follows a sinc² relationship with respect to the incident planar angle of the reference beam. The HDSS functions to adjust the reference beam planar angle to maximize the diffracted light, and thus satisfy the Bragg condition. An example of a system that would perform adequate Bragg matching may utilize a process that scans the planar angle of the reference beam and records the curve of diffracted light intensity versus planar angle at multiple data points. The system may then calculate the derivative of the sinc² curve and find the zero intercept of the derivative function, indicating the maximum diffraction efficiency. The HDSS can then direct the reference beam to the proper incident angle to maximize diffracted power. Those skilled in the art may realize other methods for optimization of the diffracted light on the detector array. One may refer to Kogelnik, “Coupled Wave Theory for Thick Hologram Gratings,” The Bell System Technical Journal., 48, 2909-2947 (1969), for further explanation of the Bragg condition for thick volume holograms.

Optionally, prior to step 504 the integration period of the detector array 103 is set to a time value by the controller 106 from its memory that is sufficiently long to provide high sensitivity to light incident the detector array and enables the peak detection of even weak light at step 505. If no peak is found at step 505, the controller increases the integration period by a predefined large step size (e.g., 10 milliseconds) stored in memory 106, and steps 504-505 are repeated. The number of reductions by this predefined step size of the integration period may be limited to a set number of times (e.g., three) before the HDSS detects an error condition.

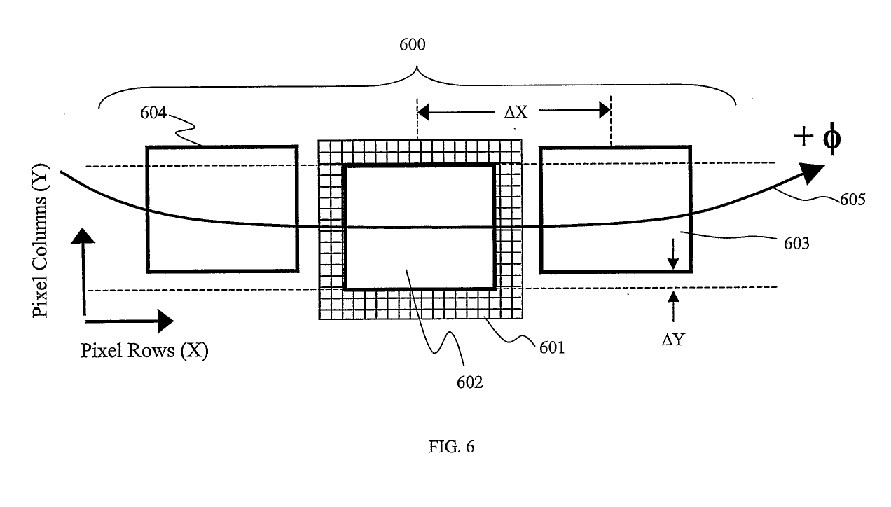

Once the planar angle θ is adjusted to optimize diffraction efficiency, it is necessary to then optimize the peristrophic incident angle φ of the reference beam to properly align the holographic reconstructed data page from the calibration hologram onto the detector array (step 506). Optimization of the peristrophic incident angle can be accomplished, in one embodiment, by detecting the edge of the holographically reconstructed image. The edge of the reconstructed image can be detected by acquiring selected rows of pixels along the image border. The column at which the image is first detected within each row is obtained and compared for several rows. The edge of the image can be detected by utilizing a typical algorithm for image edge detection. For example, one may use methods that utilize a Haar transform for edge detection, such as described in Digital Image Processing, by Kenneth R. Castleman (Prentice Hall, Englewood Cliffs, N.J. 07632) 1996, page 299, but other edge detection methods may be used. If the system determines that the image is offset due to a peristrophic angle offset, the system can adjust the peristrophic incident angle until the reconstructed image is centered on the drive detector array. For example, FIG. 6 shows the sequence of alignment of a data page image onto a pixilated detector array 601, which may represent detector 103. As the peristrophic angle increases in φ, the data page image travels across the detector array following a trajectory 605 which represents an arc of a circle of radius f• sinθ where f is the focal length of the read module and θ is the planar angle of incidence of the reference beam. The image becomes properly aligned when the peristrophic angle 4, is equal to the peristropic angle at which the hologram was recorded 602. The HDSS has the ability to detect the edge of an image as it falls on the detector array and adjust the peristropic angle accordingly to center the image on the detector array, such as described above. However, in most cases, it is necessary to achieve peristrophic alignment within a single pixel. In this case, the peristrophic angle is optimized while monitoring the BER (Bit Error Rate) of the calibration feature. In the preferred embodiment, the calibration feature will have a data set which is also stored in a memory (or memory element) of the HDSS during manufacture, allowing for BER verification of the calibration feature. The memory element in one embodiment can be a programmable memory device. The rotation of the peristrophic alignment is adjusted in a manner such that is directs the BER in a reducing direction until below a tolerance threshold value, which is stored in memory of the HDSS. In addition, or alternatively, to provide alignment within a single pixel, the alignment marks described earlier in connection with FIG. 4D may be used to obtain Δx and/or ΔAy by which are moved one or more of the reference beam 108 or media 4 (via rotary motor 5 and/or stage 10), or optics 12 or detector 103 if movable (such as on x,y and/or z translation stages).

Optionally, after finding a peak at step 505 and prior to (or after) optimizing the peristrophic incident angle at step 506, the integration period of the detector array 103 may be optimized for holographic reading of data. For example, the controller 106 may read the values of known set of pixels (e.g., 10 by p10 pixels) of the read page which when averaged should have a nominal (average) gray level value (e.g., on an 8 bit pixel value, such average may be 128). If measured average gray level value is greater or less than this nominal value, the integration period is reduced or increased, respectively, by a small step size (e.g., 1 millisecond) until the measured average valued in within a predefined tolerance, such as ±4%, of the nominal value. The detector array 103 is set to this determined integration time for subsequent reading of holographic data from the media.

Once the system calibration hologram that is first read has been reconstructed and aligned on the detector array (i.e., detector 103) using the above methods for example, it is necessary to verify that the system calibration hologram being read-back is the first hologram in the series of multiplexed system calibration holograms (step 507). Identification of the calibration hologram can, in one embodiment, be accomplished by reading a data header section that has been recorded in the system calibration hologram data page (e.g., data header 457 of FIG. 4D). Each system calibration hologram multiplexed in the same physical space on the holographic media is numbered, such that they can be sequentially read out by a known relative shift in θ and φ once the first numbered system calibration hologram is found. The header region 457 of the system calibration data page 431 can be read to determine the characteristics of the data page during read-back. In each calibration hologram the data header includes this hologram number along with such identifying characteristics of the calibration hologram, such as the reference beam incident angle values under which the calibration hologram was recorded. Thus, if the read number does not correspond to the first hologram in the series of calibration holograms, it is necessary for the HDSS to change the incident angle of the reference and/or peristrophic beam in order to find the first calibration hologram in the series. By knowing the number of the system calibration hologram actually read and from the formatting data read from the media calibration features and/or contained within the HDSS firmware and/or software, the HDSS can determine and execute the relative shift in θ and φ required (step 508 ) to be in the required angular vicinity for the HDSS′ reference beam to read out the required first system calibration hologram. At this point, it will be necessary to re-optimize the peristrophic and planar incident angles of the reference beam once again in order to properly read the next calibration hologram (step 504). Once the hologram is read-back and the data page header is analyzed, it will be clear whether or not the first hologram in the series of calibration holograms was found. If the first hologram in the series is not found, the drive can continue to offset the reference beam incident angles until the first hologram in the series of system calibration holograms is located.

If the reference beam incident angles are read for several calibration holograms that are multiplexed in the same series, it is possible to calibrate the internal drive reference beam encoders relative to the encoders that were used for recording the calibration features. In this example, the HDSS will store the header data of the read system calibration hologram in addition to the reference beam settings (e.g., θ and φ for planar angle and azimuthal multiplexing) required to read the system calibration hologram in a drive look-up table (LUT) located in RAM (step 509). For example, the values stored in the LUT may include the hologram number out of the stack of holograms, the planar and peristrophic angle at which the holograms were estimated to be recorded, the planar and peristrophic angle at which the holograms were optimally read back, the hologram radial and angular address position on the disk, and exposure dosage and time used when the holograms were recorded. An example of a calibration sequence LUT obtained from reading factory calibration features is shown in Table 1.

TABLE 1
System Calibration LUT Example

| | | | | | Expected | | | |
|---|---|---|---|---|---|---|---|---|
| | | | Disk | Disk | Peak Shift | Read Back | Read Back | |
| | Theta | Phi | Radial | Angular | due to volume | Theta | Phi | Exposure |
| Hologram | Angle | Angle | Position | Position | shrinkage | Encoder | Encoder | Time |
| Number | (deg.) | (deg.) | (a.u.) | (a.u.) | (deg.) | Position | Position | (μsec) |
| 1 | 0 | 0 | 120 | 0 | +0.01 | 120 | 120 | 20 |
| 2 | 0 | 30 | 120 | 0 | +0.01 | 120 | 30120 | 20 |
| 3 | 0 | 60 | 120 | 0 | +0.01 | 120 | 60120 | 18 |
| 4 | 0 | 90 | 120 | 0 | +0.01 | 120 | 90120 | 19 |
| 5 | 0 | 120 | 120 | 0 | +0.01 | 120 | 120120 | 20 |
| 6 | 0 | 150 | 120 | 0 | +0.01 | 120 | 150120 | 21 |
| 7 | 0 | 180 | 120 | 0 | +0.01 | 120 | 180120 | 22 |
| 8 | 1 | 0 | 120 | 0 | +0.01 | 1120 | 120 | 22 |
| 9 | 1 | 30 | 120 | 0 | +0.01 | 1120 | 30120 | 23 |
| 10 | 1 | 60 | 120 | 0 | +0.01 | 1120 | 60120 | 23 |
| 11 | 1 | 90 | 120 | 0 | +0.01 | 1120 | 90120 | 24 |
| 12 | 1 | 120 | 120 | 0 | +0.01 | 1120 | 120120 | 25 |
| 13 | 1 | 150 | 120 | 0 | +0.01 | 1120 | 150120 | 26 |
| 14 | 1 | 180 | 120 | 0 | +0.01 | 1120 | 180120 | 26 |
| 15 | 2 | 0 | 120 | 0 | +0.01 | 2120 | 120 | 27 |
| 16 | 2 | 30 | 120 | 0 | +0.01 | 2120 | 30120 | 29 |
| 17 | 2 | 60 | 120 | 0 | +0.01 | 2120 | 60120 | 31 |
| 18 | 2 | 90 | 120 | 0 | +0.01 | 2120 | 90120 | 32 |
| 19 | 2 | 120 | 120 | 0 | +0.01 | 2120 | 120120 | 35 |
| 20 | 2 | 150 | 120 | 0 | +0.01 | 2120 | 150120 | 37 |
| 21 | 2 | 180 | 120 | 0 | +0.01 | 2120 | 180120 | 40 |

Once the first calibration hologram in the series is located, the drive can continue to read subsequent holograms in the calibration series until all calibration holograms have been read and the system calibration look-up table (LUT) is fully assembled (steps 510-516). Steps 510-516 are similar to that described above in shifting θ and φ (step 508) to the address of next hologram in the calibration series, scanning θ (steps 504-505) at that address to locate and read the system calibration hologram, aligning the read data page (step 506), and storing values in the LUT (step 509). Once the holograms in the series are read, the LUT is complete. In Table 1, a.u. refers to arbitrary units in position. The number of holograms expected in the series is a number from the earlier read media calibration hologram, or a value from memory in firmware or software of the HDSS. The system calibration LUT can be examined for consistency (step 517). An inconsistent system calibration LUT may be, for example, because more than one system calibration hologram was recorded at the same location, or that the angular separation (in θ and/or φ) between system calibration holograms adjacent in the series is outside of a tolerance range read from media calibration features or from memory in firmware or software of the HDSS. If any inconsistency is found in the calibration LUT, it may be necessary to re-compile the calibration LUT by re-reading all of the calibration features. This calibration can be performed for X number of times (step 519) until a valid LUT is constructed, where X is a value stored in memory of the HDSS. For example, X may equal three or other value. If a valid LUT cannot be constructed, the HDSS may indicate for example, a “bad disk” error to the user (step 520). If the LUT is determined to be valid calibration is complete (step 518), and the LUT can be used by the HDSS to determine the angles θ, φ for reading stored holographic data pages, writing holographic data pages, and may be used in a pre-write operation prior to each write event as will be described below in connection with FIG. 7. Though Table 1 indicates that exactly twenty-one holographic system calibrations features are read, the number of holographic features may be more or less than this number. Further, although the above system calibration procedure is described using holographic features, alternatively, surface-relief grating features may be similarly scanned to provide information as to angular dimension to form a LUT.

In HDSS systems that utilize photopolymer recording media, the planar reference beam incident angle that optimizes diffraction efficiency of the system calibration hologram is not necessarily the planar incident angle of reference beam that was used to record the calibration hologram. This effect is due to volume shrinkage that is typical of photopolymer media, such as described in the earlier referenced articles by Waldman et al. The effect of volume shrinkage in photopolymer media is a deformation of holographic recording gratings. Photopolymer media can be designed to minimize volume shrinkage, however, a robust HDSS design must have the capability to optimize hologram read-back in the presence of volume shrinkage. Volume shrinkage can result in a rotation of the hologram mean grating vector. In order to properly Bragg match a hologram with a rotated grating vector, the planar incident angle of the read reference beam must be offset from the reference beam incident angle that was used during recording of the hologram. In the case of read back of system calibration holograms, the optimization of the diffraction efficiency will occur for a reference beam planar incident angle that is offset from the recording reference beam angle due to shrinkage. Once a system calibration hologram is optimized for read, it is possible to read from the data-page header for example, the expected reference beam angle shift and calibrate the internal drive coordinates to account for the volume shrinkage of the photopolymer media. In one embodiment, the expected reference angle shift due to shrinkage can be recorded in the drive LUT, as shown for example in Table 1.

A consequence of the reference beam planar incident angle adjustment is a spatial displacement of the reconstructed data page image on the detector array during hologram playback. In addition to alignment of φ as part of step 506, displacement during the data-page read can also be compensated at step 506. In the preferred embodiment, the detector array (i.e., detector 103) has additional rows and columns that border the nominal data page size. For example, a data page that contains one-thousand pixel rows and one-thousand pixel columns may be imaged on a detector array that has, for example, one-thousand and twenty-four pixel rows and one-thousand and twenty-four pixel columns. This allows the image to be displaced for a maximum range of plus or minus twelve pixels in either row or column dimension. The arrayed detector must also have the capability to move and scale the region of interest for image capture throughout a range of values. By moving the region of interest of the pixilated detector in accordance with image shift induced by compensation for volume shrinkage, it becomes possible to align the displaced data-page image to a region of interest on the pixilated detector array. After such calibration of displacement of the data page, the row offset value and column value is stored in memory of the HDSS and used when reading each recorded hologram from the media.

Once the HDSS has performed the system calibration procedure described by the flowchart of FIG. 5, the HDSS is prepared to begin a read or write event. In the preferred embodiment, the HDSS first addresses a section of the holographic media 4 designated as the Table of Contents (TOC) region. The TOC section of the disk media 4 can be located at a pre-designated location on the holographic media, for example the inner-most track on a disk media 4. FIG. 3 shows an example of a holographic disk 4 with a TOC region 302 located at the inner-most region of the holographic disk media. The HDSS positions the holographic media and/or read/write optics in order to read the information that may be located in the TOC section of the holographic media. The TOC region of the disk may be found using information from previously read media calibration features, or from memory in firmware or software of the HDSS. The TOC region may contain information that is recorded holographically and thereby read or written to using the same read/write head (e.g., optical modules 13 and 11) that the HDSS uses to read and record holographic user data. Alternatively, the TOC region may be a region of phase-change media (write-once or write-many) similar to that incorporated into recordable CDs or DVDs. The HDSS would then position a CD or DVD type optical pickup head to read such CD or DVD-compatible data. The CD or DVD-type optical pickup could be incorporated into the write optical module 13 or read optical module 11, into the servo system 7 or into the separate read system 104.

In the preferred embodiment, the TOC region contains holograms that have been recorded during previous write sessions on the holographic media. The TOC holograms contain information describing the location and properties of the data that has been written to the media in previous recording sessions. The information contained in such TOC holograms may include for example, the positions of the holograms previously recorded on the disk, the file or directory structure of the recorded data, or media conditions observed during the previous write (e.g., storage capacity, media sensitivity, or extent of volume shrinkage). Once the HDSS has positioned the media and/or optics to read a TOC hologram, the HDSS can attempt to read the hologram at the first TOC location in the holographic media. The proper drive degrees of freedom for reading a TOC hologram can be recalled from the LUT that was obtained during initial drive calibration from factory calibration features in addition to location information obtained by reading the previously described media calibration features. This requires that all TOC holograms are recorded in accordance with the LUT obtained during HDSS calibration. Once the first TOC hologram is read, each subsequent TOC hologram is located and read. The location of each TOC hologram in a series of recorded TOC holograms is determinable since the address (radial and angular position and the angular separation in θ and/or φ) of the next TOC hologram recorded (or will be recorded) in the TOC region is information stored in the previous read TOC hologram. In one example, if in reading TOC holograms, no TOC hologram is found at the next expected location, then the HDSS has read all TOC holograms. In a second example, where the holographic media is erasable, if in reading TOC holograms, a specific data page or collection of data bits designating an end of file are read, then the HDSS has read all TOC holograms. Each TOC hologram may contain a data page number, or other unique identifier(s), to identify the order of each TOC hologram recorded, and thus enable the HDSS to determine and scan for any TOC holograms (similar to that performed at step 504 or 512) which may have been missed. If the disk has had content written previously to the media, the first hologram in the TOC series will contain information that describes the first write event of the disk's history. If no hologram is stored in the first address of the TOC region, it will be a clear indicator that no prior write event has been performed on the disk. The TOC holograms can thus contain a plurality of information indicating the contents of the holographic disk. The HDSS can notify the user or host computer 112 (FIG. 1) of the previous data content, via controller 106, or lack of data content recorded in the media. At this point in the operation of the HDSS, the user can choose to read previously recorded data that has been identified by the TOC holograms, or alternatively, the user can choose to begin a write sequence, where new data is to be recorded to the inserted media 4 in the HDSS.

If the user desires to record data in the media, the HDSS may perform a performance calibration sequence shown in FIG. 7. The performance calibration sequence described below is believed to be required for holographic media wherein the sensitivity or dynamic range may change appreciably over the lifetime of the media, such as may occur for example due to temperature and humidity stresses. In the preferred embodiment, the performance calibration sequence requires that holographic calibration features are recorded using the HDSS drive operated by the end-user, rather than at a factory HDSS. These calibration features are performance calibration features and within each feature is a plurality of performance calibration holograms, wherein each hologram is identical in format to a system calibration hologram, see for example FIG. 4D, but are termed performance calibration features since they are written and read back by a user HDSS drive in order to ascertain the properties of the media prior to a write event. For media that changes nominally with environmental factors such as time since manufactured, temperature history, and humidity history, these calibration features are not necessary and the HDSS can determine performance properties of the media by reading information stored in the media calibration features. However, for holographic media that may change over time, an HDSS may be programmed to read the media calibration features and then test the response of the media by writing and reading back a performance calibration feature. The writing and subsequent reading of performance calibration features can indicate many properties of the media that may include for example, available data capacity, media photosensitivity and extent of media volume shrinkage. The HDSS can use the results of recording and reading performance calibration features to inform the user of the media properties, such as available media capacity, or the results of recording and reading performance calibration features can be used to determine the proper recording parameters for data recording, including for example, exposure energy dosage or hologram theta and phi addresses.

To begin the pre-write sequence (step 701), the HDSS must locate the first available space for writing holograms. In the preferred embodiment, the holographic media 4 is divided into sectors 303 (FIG. 3), where each sector contains a region 307 for recording performance calibration holograms. An alternative embodiment may not use sector designations to divide the regions of the holographic. The location of the first available disk sector or address can be obtained by reading the TOC holograms since the last TOC record has information as to sectors or addresses available. Optionally, a map may be generated in memory of the information read from TOC hologram(s) as to where within the media holograms have been already encoded, such as may be determined by TOC information as to the address (physical radial and angular position relative to tracks or sectors along the disk), θ and φ angles recorded, and exposure time (i.e., amount of laser power used, as each successive co-locational hologram is recorded at a different laser exposure dose). The HDSS locates the first sector having an available address on the holographic media. Once the media and/or read/write optics are positioned at the performance calibration areas of the first available sector (step 702), the HDSS records a sequence of performance calibration holograms (step 703) which preferably are identical to the series of holograms read-back from system calibration and are outlined in the system calibration LUT. Each of the performance calibration holograms are recorded and read by the HDSS (step 704). The read sequence may require optimization of the drive parameters such as theta and phi angles of the reference beam in order to align the calibration reconstructed image on the detector array, similar to that shown at steps 504-506 (FIG. 5) to align the image on the detector. Upon reading each performance calibration hologram, the HDSS may record several statistics pertaining to the characteristics of each hologram. For instance, the drive may store these performance statistics in another LUT, such as shown for example in Table 2 below. The performance features stored in the LUT may include for example, the diffraction efficiency of each hologram, the BER and/or SNR of each hologram, the photosensitivity of the media, or the observed reference beam shift between the recorded and read-back performance feature holograms (indicating volume shrinkage). The diffraction efficiency (η) of each performance calibration hologram can be determined by comparing the total light diffracted from the hologram (I_{diff}) and the reference beam incident light used to read the hologram (I_{ref}). The diffraction efficiency is calculated as:

$$η = \frac{{I}_{diff}}{{I}_{ref}} \qquad ( 2 )$$

I_{diff} and I_{ref} may also be obtained by calibrated photodiodes and associated optics that couple a small portion of the incident and diffracted light, respectively, into the appropriate detectors for calculating the diffraction efficiency. Alternatively, photodiodes in conjunction with the detector array 103 may be used to determine diffraction efficiency. Once the diffraction efficiency is determined, the HDSS can determine the photosensitivity of the media during recording. The photosensitivity can be expressed as:

$$Photosensitvity = \frac{{η}^{1 / 2}}{Idt} ( cm / J ) \qquad ( 3 )$$

where η is diffraction efficiency, I is the average total light intensity (e.g., intensity of the object beam plus that of the reference beam) used to record the hologram (reference plus object beam light), d is the recording layer thickness, and t is the exposure time used to record the hologram. The HDSS can obtain the recording layer thickness for example, by an earlier read of the media calibration features.

Except for photosensitivity and diffraction efficiency, these performance features are determined in the same manner described earlier with the system calibration holograms. The HDSS can then utilize the performance statistics to determine if the media is suitable for recording (step 705). The HDSS can then determine the available capacity of the media (step 706) and the energy dosage required to write a series of data holograms (referred to as exposure scheduling). The user may also be notified of the available capacity and estimated recording time associated with such energy dosage from source 15 of FIG. 1 (step 707).

TABLE 2
Performance Calibration LUT Example

| | | | | | Measured | Read Back | Read Back | | | |
|---|---|---|---|---|---|---|---|---|---|---|
| | Theta | Phi | Disk | Disk | Peak Shift | Theta | Phi | | | |
| | Angle for | Angle for | Radial | Angular | due to volume | Encoder | Encoder | Photo | | Exposure |
| Hologram | Recording | recording | Position | Position | shrinkage | Position | Position | Sensitivity | Diffraction | Time |
| Number | (deg) | (deg) | (au) | (au) | (deg) | (au) | (au) | (cm/mJ) | Efficiency | (μs) |
| 1 | 0 | 0 | 120 | 10 | +0.009 | 120 | 120 | 11.7 | .002 | 20 |
| 2 | 0 | 30 | 120 | 10 | +0.009 | 120 | 30120 | 11.7 | .002 | 20 |
| 3 | 0 | 60 | 120 | 10 | +0.009 | 120 | 60120 | 11.6 | .002 | 18 |
| 4 | 0 | 90 | 120 | 10 | +0.009 | 120 | 90120 | 11.6 | .003 | 19 |
| 5 | 0 | 120 | 120 | 10 | +0.009 | 120 | 120120 | 11.6 | .003 | 20 |
| 6 | 0 | 150 | 120 | 10 | +0.009 | 120 | 150120 | 11.6 | .003 | 21 |
| 7 | 0 | 180 | 120 | 10 | +0.009 | 120 | 180120 | 11.6 | .003 | 22 |
| 8 | 1 | 0 | 120 | 10 | +0.009 | 1120 | 120 | 11.5 | .003 | 22 |
| 9 | 1 | 30 | 120 | 10 | +0.009 | 1120 | 30120 | 11.5 | .003 | 23 |
| 10 | 1 | 60 | 120 | 10 | +0.009 | 1120 | 60120 | 11.5 | .004 | 23 |
| 11 | 1 | 90 | 120 | 10 | +0.009 | 1120 | 90120 | 11.5 | .004 | 24 |
| 12 | 1 | 120 | 120 | 10 | +0.009 | 1120 | 120120 | 11.4 | .003 | 25 |
| 13 | 1 | 150 | 120 | 10 | +0.009 | 1120 | 150120 | 11.4 | .002 | 26 |
| 14 | 1 | 180 | 120 | 10 | +0.009 | 1120 | 180120 | 11.4 | .003 | 26 |
| 15 | 2 | 0 | 120 | 10 | +0.009 | 2120 | 120 | 11.4 | .002 | 27 |
| 16 | 2 | 30 | 120 | 10 | +0.009 | 2120 | 30120 | 11.4 | .004 | 29 |
| 17 | 2 | 60 | 120 | 10 | +0.009 | 2120 | 60120 | 11.4 | .004 | 31 |
| 18 | 2 | 90 | 120 | 10 | +0.009 | 2120 | 90120 | 11.3 | .004 | 32 |
| 19 | 2 | 120 | 120 | 10 | +0.009 | 2120 | 120120 | 11.3 | .004 | 35 |
| 20 | 2 | 150 | 120 | 10 | +0.009 | 2120 | 150120 | 11.3 | .004 | 37 |
| 21 | 2 | 180 | 120 | 10 | +0.009 | 2120 | 180120 | 11.3 | .003 | 40 |

Methods for determining exposure schedule in holography of photopolymer recording may be used, such as described in Pu A, Curtis K, and Psaltis D, “Exposure Schedule For Multiplexing Holograms In Photopolymer Films.” Opt Eng 35 (10), 2824-2829 (1996). In this manner, the HDSS can dynamically measure and characterized the amount of prerecorded polymerization at an added in the sector where data will be recorded to ensure quality of such recording. Available capacity for additional data storage may be determined such as described fir example in G. J. Steckman et al., Storage density of shift-multiplexed holographic memory, Appl. Opt., 40, 3387-3394, 2001.

Once the HDSS has recorded performance calibration features, read such calibration features, obtained the performance statistics of the media and determined the proper exposure schedule and available capacity, the HDSS can perform a write event where user data is written to the holographic media.

After each write event or write session of multiple write events, the HDSS writes a new TOC hologram to the TOC region of the media having information about the hologram(s) written, such as their address (physical space) on the disk, which may be relative to tracks along the disk, θ and φ angles when recorded, exposure time, date and time recorded, file name, size, encoding scheme, addresses still unused, or title or other descriptive data about the recorded data. As stated earlier, the address of each TOC hologram to be written may be found at an address read by the media calibration features or from memory in firmware or software of the HDSS. Thus, such TOC holograms may be read by the HDSS when a disk is first installed in the HDSS, as described earlier, to provide information about data already recorded on the media disk.

From the foregoing description it will be apparent that there has been provided holographic data storage media containing a variety of calibration features for the use by the HDSS obtaining media and format information, opto-mechanical alignment calibration, and to determine the performance characteristics of media as well as systems, methods and apparatuses for holographic data storage utilizing media with such calibration features. The illustrated description as a whole is to be taken as illustrative and not as limiting of the scope of the invention. Such variations, modifications and extensions, which are within the scope of the invention, will undoubtedly become apparent to those skilled in the art.

1-60. (canceled)

61. An apparatus for holographic data storage utilizing holographic data storage media comprising:
a light source providing a reference beam;
read optics for directing said reference beam to said media to produce return light from said media representing holographic data, said read optics having one or more beam steering devices for positioning said reference beam to the media;
a detector for detecting said returned light from the media to provide said holographic data;
said media having a plurality of calibration features; and
a controller for controlling the positioning of said beam steering devices to align said beam steering devices to direct the reference beam for reading each of said calibration features until the calibration feature when illuminated by the reference beam provides return light onto said detector representing holographic data associated with the calibration feature, and said controller having memory storing the position of the reference beam in accordance with the aligned position of said beam steering devices for each of the calibration features for use by said controller for aligning said read optics for future positioning of the reference beam.

62. The apparatus according to claim 61 having one or more rotational or translation stages for positioning said media with respect to said read optics and said write optics.

63. The apparatus according to claim 61 further comprising:
optics for dividing said beam from said light source into said reference beam and an object beam;
write optics for utilizing said object beam in combination with said reference beam from said read optics to write holographic data to the media, and said write optics having a modulator for modulating said object beam in accordance with the data to be written, and a shutter blocking said object beam when said controller utilizes said read optics to read holographic data from the media; and
said controller controls said shutter and provide data to said modulator when data is to be written to said media.

64. The apparatus according to claim 63 wherein said controller utilizes said write optics and read optics to write a plurality of holograms onto the media, and utilizes said read optics and detector to read said plurality of holograms to determine at least one of storage capacity of said media, and energy required from the light source to write holographic data.

65. The apparatus according to claim 63 wherein said light source, read optics, write optics, and detector are provided for in a common housing into which said media is receivable.

66. The apparatus according to claim 61 wherein said plurality of calibration features represent first calibration features, said media has one or more second calibration features storing at least information for locating said first calibration features, and said apparatus further comprising a reader for reading said second calibration features.

67. The apparatus according to claim 61 wherein said media has at least one region for storing one or more holograms recording a table of contents of holographic data previously stored on said media, and said controller utilizes said read optics and detector to read said holograms recording the table of contents of said media.

68. The apparatus according to claim 63 wherein said media has at least one region for storing one or more holograms recording a table of contents of holographic data previously stored on said media, and said controller utilizes said write optics and read optics to write another hologram updating the table of contents to reflect the holographic data after being written onto said media.

69. Holographic data storage media for use by holographic data storage systems having optics positional with respect to said media to direct at least one reference beam to said media in order to read holographic data stored therein, said media comprising:
a plurality of calibration features wherein each disposed in or on said media to be read at different angular dimensions over which said optics are capable of being positioned at a location with respect to said media to enable holographic data storage systems each when presented to said media to calibrate the positioning of said optics at angular dimensions with respect to the media for reading said calibration features.

70. The media according to claim 69 wherein each of said calibration features has data uniquely defining the calibration feature.

71. The media according to claim 69 wherein said calibration features are one of relief gratings on or in said media, or holograms recorded in said media.

72. The media according to claim 69 wherein said calibration features represent first calibration features, and said media further comprises:
one or more second calibration features at a predetermined location on said media having at least information readable by the holographic data storage systems when presented to said media in locating at least the approximate location of said each of said first calibration features with respect to said media.

73. The media according to claim 72 wherein said one of more second calibration features each represent one of amplitude optical signal varying or magnetically encoded data.

74. The media according to claim 69 further comprising predefined regions of said media for storage of said calibration features.

75. The media according to claim 74 further comprising a least one predefined region where at least one of said holographic data storage systems when presented with said media writes and then reads a plurality of calibration holograms at different dimensions over which said optics of said one of said holographic data storage systems are positional with respect to the media to determine characteristics of said media.

76. The media according to claim 75 wherein said characteristics comprise one or more of volume shrinkage of said media, extent of polymerizations, energy dosage or photosensitivity for hologram writing, thermal effects, and available data storage capacity of said media.

77. The media according to claim 69 wherein said calibration features are co-locational holograms recorded in said media at different ones of said angular dimensions.

78. The media according to claim 69 wherein one of said dimensions is angular position with respect to said media representing the tilt of said media with respect to said optics.

79. The media according to claim 69 wherein one of said dimensions is the azimuthal angular position with respect to said media.

80. Holographic data storage media for use by different holographic data storage systems each having optics positional with respect to said media to at least read holographic data, said media comprising:
calibration features representing holograms written by a holographic data storage systems when presented with said media at different angularly dimensions over which said optics are positional with respect to said media, in which said calibration features are read by the holographic data storage system to determine characteristics of said media, said characteristics comprising one or more of volume shrinkage of said media, extent of polymerizations, energy dosage or photosensitivity for hologram writing, thermal effects, and available data storage capacity of said media.

81. An improved holographic data storage system for storing data on holographic data storage media, said system having optics positional with respect to said media to direct a reference beam to said media in order to at least read data stored in said media on a detector, the improvement comprising:
means for reading a plurality of calibration features disposed in or on said media at one or more different angular dimensions over which said optics are capable of being positioned at a location with respect to said media to enable the holographic data storage system to calibrate the positioning of said optics with respect to the media by reading each of said calibration features.

82. The system according to claim 81 wherein each of said calibration features has data uniquely defining the calibration feature.

83. The system according to claim 81 wherein said calibration features are one of relief gratings on or in said media, or holograms recorded in said media.

84. The system according to claim 81 wherein said calibration features represent first calibration features, and said system further comprises:
means for reading one or more second calibration features at a predetermined location on said media having at least information readable by the holographic data storage system when presented to said media in locating at least the approximate location of said each of said first calibration features with respect to said media.

85. The system according to claim 84 wherein said means for reading said one or more second calibration features is separate from said means for reading said first calibration features.

86. The system according to claim 84 wherein said one of more second calibration features each represent one of amplitude optical signal varying or magnetically encoded data.

87. The system according to claim 81 wherein each of said calibration features has data defining the calibration feature, one of said dimensions represents angular position with respect to said media, and said means determines the suitable angular position of each of said calibration features with respect to said optics by detecting the signal representing the data of said calibration feature on the detector.

88. The system according to claim 87 wherein another one of said dimensions represents the azimuthal angular position with respect to said media, and said means determines the suitable azimuthal angular position of each of said calibration features with respect to said optics by detecting the signal representing the data of said calibration feature on the detector.

89. The system according to claim 88 wherein said signal to determine the suitable azimuthal angular position is by detecting the azimuthal angular position of each of the read calibration features which positionally aligns the data of the read calibration feature on the detector.

90. The system according to claim 88 wherein said signal to determine suitable azimuthal angular position is by detecting the azimuthal angular position of each of the read calibration features which reduces the error rate of at least a part of the data of the read calibration feature.

91. The system according to claim 89 further comprising means for positioning said detector in one or more x, y, or z orthogonal dimensions to reduce the error rate of at least a part of the data of the read calibration feature

92. The system according to claim 81 further comprising:
means for writing calibration features representing holograms in said media at different angular dimensions over which said optics are capable of being positioned at a location with respect to said media, in which said calibration features are read by the holographic data storage system to determine characteristics of said media, said characteristics comprising one or more of volume shrinkage of said media, extent of polymerizations, energy dosage or photosensitivity for hologram writing, thermal effects, and available data storage capacity of said media.

93. A system for calibrating a holographic data storage apparatus to holographic data storage media in which the apparatus has optics positional with respect to said media to enable reading and writing holographic data, said system comprising:
means for writing calibration features representing holograms in said media at different angular dimensions over which said optics are capable of being positioned one or more locations with respect to said media; and
means for reading said calibration features to determine characteristics of said media, said characteristics comprising one or more of volume shrinkage of said media, extent of polymerizations, energy dosage or photosensitivity for hologram writing, thermal effects, and available data storage capacity of said media.

94. A method for calibrating holographic data storage media for use in a holographic data storage system, in which said system has optics positional with respect to said media to direct a reference beam to said media in order to at least read data stored in said media on a detector, the method comprising the steps of:
reading a plurality of calibration features disposed in or on said media at one or more different angular dimensions over which said optics are capable of being positioned at one or locations with respect to said media; and
calibrating the positioning of said one or more angular dimensions of said optics with respect to said media to allow said holographic data storage system to read each of said calibration features.

95. A method for calibrating holographic data storage media for use in a holographic data storage system, in which said system has optics positional with respect to said media to direct a reference beam and an object beam to said media in order to write data in said media, and to direct the reference beam to said media in order to read data on a detector, comprising the steps of:
writing calibration features representing holograms in said media at different angular dimensions over which said optics are positional with respect to said media; and
reading said calibration features to determine characteristics of said media, said characteristics comprising one or more of volume shrinkage of said media, extent of polymerizations, energy dosage or photosensitivity for hologram writing, thermal effects, and available data storage capacity of said media.

96. Holographic media comprising a region for storing data having phase change material capable of being recorded by one of a CD or DVD optical recording means.
